(19) United States
(12) Patent Application Publication
(10) Pub. No.: US 2026/0326604 A1
(43) Pub. Date: Oct. 22, 2026

(54) SOA-BASED INTELLIGENT RECHARGE CONTROL METHOD FOR VEHICLE, DEVICE, MEDIUM, AND VEHICLE

(71) Applicant: CHONGQING CHANGAN AUTOMOBILE CO., LTD., Chongqing (CN)

(72) Inventor: Haohua YIN, Chongqing (CN)

(73) Assignee: CHONGQING CHANGAN AUTOMOBILE CO., LTD., Chongqing (CN)

(21) Appl. No.: 19/707,389

(22) Filed: Jun. 15, 2026

Related U.S. Application Data
(63) Continuation of application No. PCT/CN2024/143405, filed on Dec. 27, 2024.

(30) Foreign Application Priority Data
Jan. 2, 2024 (CN) 202410004431.9

(51) Int. Cl. B60L 53/62; B60L 53/66; B60L 53/68

(52) U.S. Cl. CPC B60L 53/62; B60L 53/66; B60L 53/68

(57) ABSTRACT

Provided are an SOA-based intelligent recharge control method for a vehicle, a device, a medium, and a vehicle. The method includes: acquiring, by an intelligent recharge system of a system service layer, information from a basic service layer, an enhanced service layer, and an atomic service layer, and determining whether a trigger condition for an intelligent recharge service is satisfied; when the trigger condition is satisfied, calculating, by the intelligent recharge system, recharge information based on environmental and vehicle body information; receiving, by the basic service layer, an instruction from the intelligent recharge system to control the vehicle to be applied with a high voltage, and performing recharge according to a recharge duration; after the recharge ends, controlling, by the intelligent recharge system, the vehicle to exit the recharge, and sending process record information to a cloud platform through a communication interface of the basic service layer for analysis.

### CROSS-REFERENCE TO RELATED APPLICATION

This application is a continuation of International PCT Application No. PCT/CN 2024/143405, filed on Dec. 27, 2024, which claims priority to Chinese Patent Application No. CN202410004431.9, filed with the China National Intellectual Property Administration on Jan. 2, 2024 and entitled “SOA-BASED INTELLIGENT RECHARGE CONTROL METHOD FOR VEHICLE, DEVICE, MEDIUM, AND VEHICLE”. The two applications are incorporated herein by reference in their entireties.

### BACKGROUND

### Technical Field

The present application relates to the technical field of vehicle body control, and specifically to an SOA-based intelligent recharge control technology for a vehicle.

### Description of Related Art

With the continuous development of automobile manufacturing technology, people's requirements for vehicles are also getting higher and higher. How to further meet the personalized requirements of users and place greater emphasis on ride comfort, safety, and environmental friendliness has become an important issue in vehicle body control.

SOA (service-oriented architecture) is a component model that splits different functional units (also known as services) of an application and connects them through well-defined interfaces and protocols between these services. The interfaces are defined in a neutral manner, independent of the hardware platform, operating system, and programming language that implement the services. This allows services built in various systems to interact in a unified and universal manner. Therefore, in applications, the SOA splits different functional units of an application, encapsulates the smallest functional logic into services, and realizes the mutual interaction of different functional logic modules and data interaction by calling service interfaces.

Traditional vehicles use a distributed electronic and electrical architecture, where various functions are controlled by dozens or hundreds of electronic control units (ECUs). These ECUs all use embedded software, with a deep binding of software and hardware, making it difficult to upgrade, let alone achieve collaborative work. In the traditional software architecture, hardware and software are highly coupled, and signal-based communication lacks flexibility and scalability. Even minor functional changes can cause adjustments to the full-vehicle software. The SOA changes the cross-ECU interaction from “signal-based communication” to “service-based communication”, making the application service-oriented and available for anyone to use freely within the scope of permission, thereby making full-vehicle intelligence possible. The flexible deployment of services allows different vehicle configurations to have different service deployments during the full-vehicle lifecycle, greatly reducing the coupling between software and hardware, and enabling faster software updates and upgrades.

As new energy vehicles enter more and more households, the performance difference in the full-vehicle's electrical energy management determines whether a new energy vehicle can succeed in the fierce vehicle market competition. Based on the application of intelligent power distribution modules in an electronic and electrical architecture of the new generation of intelligent vehicle, intelligent energy-saving management based on actual conditions, such as vehicle status information and environmental information like outside temperature, full-vehicle voltage, basic counter unit (BCU) remaining power, and BCU long-term discharge power, has become possible. Therefore, using an SOA, users can reorganize the intelligent recharge function to meet the requirements of personalized customization.

### SUMMARY

Aiming at the problems existing in the prior art, the present application provides an SOA-based intelligent recharge control method for a vehicle, a device, a medium, and a vehicle, which realizes modular vehicle recharge services through the SOA, thereby improving the flexibility, scalability, and maintainability of the recharge function.

The technical solutions of the present application are as follows.

In a first aspect, the present application provides an SOA-based intelligent recharge control method for a vehicle, where the adopted SOA divides a software architecture into at least five layers, including: a system service layer, a basic service layer, an enhanced service layer, an atomic service layer, and an input/output (I/O) abstraction layer. The SOA-based intelligent recharge control method for the vehicle specifically comprises the following steps.

A intelligent recharge system service of the system service layer acquires information from the basic service layer, the enhanced service layer, and the atomic service layer, and determines whether a trigger condition for an intelligent recharge service is satisfied.

When the trigger condition is satisfied, the intelligent recharge system service calculates recharge information based on environmental and vehicle body information, where the recharge information includes a recharge duration.

A high voltage request basic service of the basic service layer receives an instruction from the intelligent recharge system service to control the vehicle to be applied with a high voltage, and performs recharge according to the recharge duration.

Further, the system service layer starts the intelligent recharge system service when the trigger condition is satisfied, where the trigger condition includes a primary trigger condition and a secondary trigger condition, and the intelligent recharge service can be started only when the primary trigger condition and the secondary trigger condition are both satisfied.

In an implementation, there are two scenarios that satisfy the primary trigger condition, which are as follows.

The first scenario is that after a preset duration of full-vehicle locking, a power supply voltage atomic service of the atomic service layer acquires a full-vehicle voltage value, the system service layer calculates an average voltage value, and when the average voltage value is lower than a preset value, the primary trigger condition is satisfied. Generally, the preset duration of full-vehicle locking is 20 to 60 minutes.

The second scenario is that after a full-vehicle network is completely asleep, when a semiconductor control rectifier (SCR) core processor monitors that a voltage of the I/O abstraction layer is lower than a preset value, the primary trigger condition is satisfied, and a microprogrammed control unit (MCU) is awakened.

Further, after the primary trigger condition is satisfied, the intelligent recharge system service pulls up the full-vehicle network through the basic service layer, acquires vehicle information and environmental information of a vehicle controller (VIU), and determines whether the secondary trigger condition is satisfied.

Determining whether the secondary trigger condition is satisfied comprises: acquiring, through each basic service in the basic service layer, whether a remaining available power of a power battery is sufficient, whether a long-term discharge power of the power battery is sufficient, and whether a high voltage system is operating normally; determining whether the full-vehicle network is operating normally; and if all the above determinations are normal, then determining that the secondary trigger condition is satisfied.

Further, after the trigger condition is satisfied, the intelligent recharge system service determines the recharge duration and other parameters based on environmental and vehicle body information, thereby performing recharge for the vehicle. These parameters include a period for anomaly detection, a period and filtering parameters for voltage detection, and a waiting time between triggers of two recharges.

Further, an end of the recharge includes a normal end and an abnormal end. When a certain exit condition is satisfied, the intelligent recharge service normally ends the recharge of the vehicle; when a certain disconnection condition is satisfied, the intelligent recharge system service abnormally ends the recharge of the vehicle.

Further, after the abnormal end, an MCU wake-up mode atomic service of the atomic service layer calls an MCU wake-up mode I/O abstraction service of the I/O abstraction layer to send an instruction to an SCR core to periodically wake up the vehicle; and after an occurrence count of an anomaly exceeds a set value, a disable instruction is sent to the SCR core until the vehicle is unlocked.

In a second aspect, the present application further provides an electronic device, including: one or more processors; and a storage apparatus, configured to store one or more programs, where when the one or more programs are executed by the one or more processors, the electronic device is caused to implement the SOA-based intelligent recharge control method for the vehicle provided in the first aspect above.

In a third aspect, the present application further provides a computer-readable storage medium, having a computer program stored thereon, where when the computer program is executed by a processor of a computer, the computer is caused to execute the SOA-based intelligent recharge control method for the vehicle as described above. The computer-readable storage medium may be included in the electronic device described in the second aspect above, or may exist independently without being assembled into the electronic device.

In a fourth aspect, the present application further provides a vehicle, where the vehicle is provided with an electronic device, the electronic device including: one or more processors; and a storage apparatus, configured to store one or more programs, wherein when the one or more programs are executed by the one or more processors, the electronic device is caused to implement the SOA-based intelligent recharge control method for a vehicle as described in the first aspect of the present application.

By adopting the technical solutions described in the above aspects, the present application has at least the following beneficial effects.

The present application adopts an SOA including a system service layer, a basic service layer, an enhanced service layer, an atomic service layer, and an I/O abstraction layer. An intelligent recharge system service of the system service layer acquires information from the basic service layer, the enhanced service layer, and the atomic service layer, and determines whether a trigger condition for an intelligent recharge service is satisfied; when the trigger condition is satisfied, the intelligent recharge system service calculates recharge information based on environmental and vehicle body information, where the recharge information includes a recharge duration; a high voltage request basic service of the basic service layer receives an instruction from the intelligent recharge system service to control the vehicle to be applied with a high voltage, and performs recharge according to the recharge duration; and after the recharge ends, the intelligent recharge system service controls the vehicle to exit the recharge, and sends process record information to a cloud platform through a communication interface of the basic service layer. Through the above SOA, a modular vehicle recharge service function is realized. The system is organized in a loosely coupled manner through the SOA, allowing different services to be developed and maintained by different teams, and to be extended and modified independently. Furthermore, the above SOA also has high flexibility and reusability because services can be shared and reused between different systems and applications, thereby improving the flexibility, scalability, and maintainability of the vehicle recharge service function.

### BRIEF DESCRIPTION OF DRAWINGS

FIG. 1 is a flowchart of an SOA-based intelligent recharge control method for a vehicle according to an embodiment of the present application.

FIG. 2 is a schematic diagram of an SOA according to an embodiment of the present application.

FIG. 3 is a simplified diagram of an SOA according to an embodiment of the present application.

### DESCRIPTION OF EMBODIMENTS

The technical solutions in the embodiments of the present application will be clearly and completely described below with reference to the accompanying drawings in the embodiments of the present application. It should be understood that the specific embodiments described herein are only used to explain the related application, and are not intended to limit the relevant application. It should also be noted that, for ease of description, only the parts related to the relevant application are shown in the drawings.

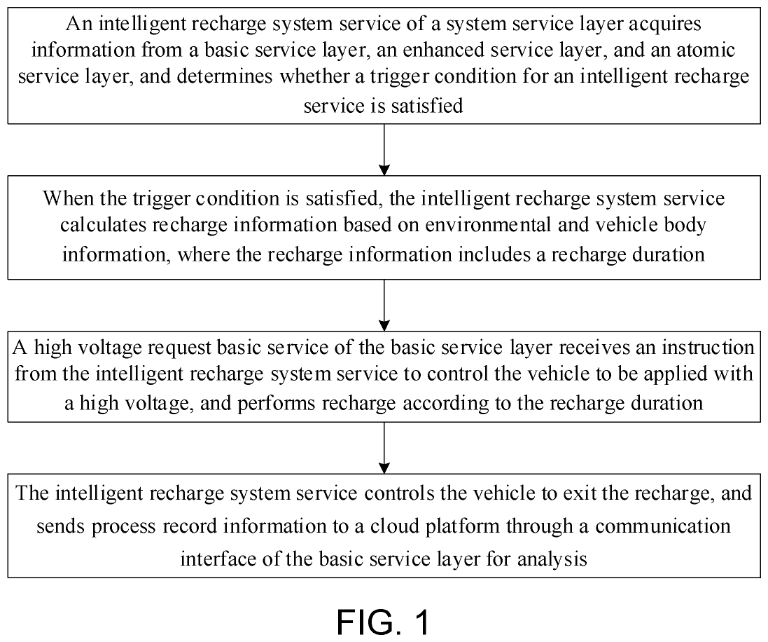

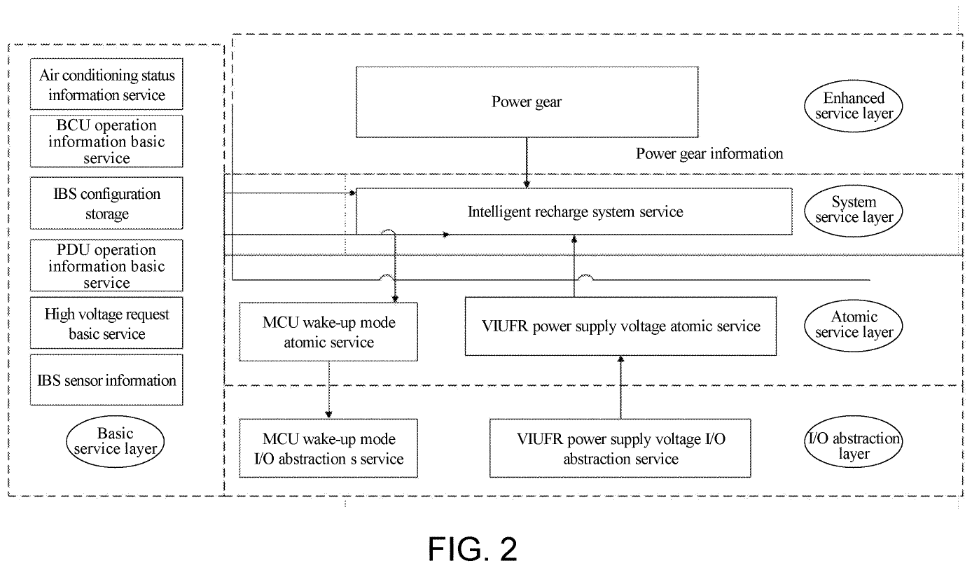

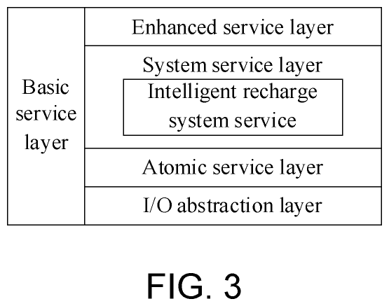

In order to solve the problems existing in the prior art, an embodiment of the present application provides an SOA-based intelligent recharge control method. As can be seen in combination with FIG. 1, FIG. 2, and FIG. 3, the method adopts an SOA, which specifically includes: a system service layer, a basic service layer, an enhanced service layer, an atomic service layer, and an I/O abstraction layer. The layered logic is designed so that developers can focus only on the part they are responsible for, and for external systems, it is only necessary to ensure that the input parameters are correct.

The system service layer includes an intelligent recharge system service Sys_IntLoBattChrg. This system service layer is used to acquire real-time full-vehicle information, arbitrate related conditions, and then request function calls from the enhanced service layer. The system service layer includes an intelligent recharge system service. Specifically, the system service layer receives full-vehicle information acquired in real time through various basic services from the basic service layer, receives power supply voltage information from the atomic service layer, and starts an intelligent recharge service when it is determined that a trigger condition is satisfied by calling a power gear service Enh_PowerShiftDrv of the enhanced service layer.

The enhanced service layer is responsible for filtering parameters for requests sent from the system service layer, and when multiple requests are received, selecting which service to execute according to a preset priority order, and returning a requested parameter. The enhanced service layer includes the power gear service, which internally implements priority selection and provides power gear parameter calls for the system service layer.

The basic service layer includes basic services related to recharge control, used for bidirectionally transmitting information between CAN lines, LIN lines, and application programs, i.e., transparently transmitting message information sent from the CAN lines and rgw LIN lines to the application or vice versa. Specifically, as shown in the figures, the basic service layer includes various basic services related to recharge control, such as: a high voltage request basic service Basc_HvActvReq, a BCU operation information basic service, a protocol data unit (PDU) operation information basic service Basc_PduOperInfo, an intelligent battery sensor (IBS) configuration storage Basc_DID, an IBS sensor information Basc_IBSInfo, an air conditioning status information service Basc_ACStsInfo, etc.

The atomic service layer is used to shield the impact of changes in the I/O abstraction layer on the upper layers, reduce the modification of software when functions are changed, and achieve decoupling. Through this atomic service layer, the dependency between different codes is reduced, and the impact of changes in other codes on itself is reduced as much as possible. Specifically, the atomic service layer includes an MCU wake-up mode atomic service Atm_WUType and a power supply voltage atomic service Atm_VIUFRU.

The I/O abstraction layer is used to bind with the hardware layer and shield the hardware design and specific implementations. Specifically, this I/O abstraction layer provides an MCU wake-up mode I/O abstraction service IO_WUType and a power supply voltage I/O abstraction service IO_VIUFRU. The interfaces provided by the I/O abstraction layer are only visible to the atomic service layer, and other layers cannot call them directly.

In some embodiments of the present application, as shown in FIG. 1, the SOA-based intelligent recharge control method for a vehicle specifically includes the following steps.
Step 1: an intelligent recharge system service of the system service layer acquires information from the basic service layer, the enhanced service layer, and the atomic service layer, and determines whether a trigger condition for an intelligent recharge service is satisfied.
Step 2: when the trigger condition is satisfied, the intelligent recharge system service calculates recharge information based on environmental and vehicle body information, where the recharge information includes a recharge duration.
Step 3: a high voltage request basic service of the basic service layer receives an instruction from the intelligent recharge system service to control the vehicle to be applied with a high voltage, and performs recharge according to the recharge duration.
Step 4: after the recharge ends, the intelligent recharge system service controls the vehicle to exit the recharge, and sends process record information to a cloud platform through a communication interface of the basic service layer for analysis.

In some embodiments of the present application, the intelligent recharge service of the system service layer is started when the trigger condition is satisfied to perform recharge for the vehicle. The trigger condition includes a primary trigger condition and a secondary trigger condition. The intelligent recharge service can be started only when the primary trigger condition and the secondary trigger condition are both satisfied.

In some embodiments of the present application, the primary trigger condition may be satisfied in the following two scenarios.

The first scenario is that after a preset duration of full-vehicle locking, a full-vehicle voltage value is acquired through an Atm_VIUFRU power supply voltage atomic service of the atomic service layer, an average voltage value is calculated inside the system service layer, and when the average voltage value is lower than a preset value, the intelligent recharge system service is triggered.

According to actual requirements, in a preferred design herein, the preset duration of full-vehicle locking is set to 20 to 60 minutes.

The second scenario is that after a full-vehicle network is completely asleep, when an SCR core processor of the vehicle monitors that a voltage of the I/O abstraction layer is lower than a preset value, an MCU is awakened.

In some embodiments of the present application, after the system service layer is triggered primarily, the intelligent recharge system service pulls up the full-vehicle network through the IBS sensor information Basc_IBSInfo of the basic service layer, acquires remaining vehicle information and environmental information of a vehicle controller VIU through other basic services of the basic service layer (as shown in FIG. 1, including the high voltage request basic service, the BCU operation information basic service, the PDU operation information basic service, the air conditioning status information service, etc.), and further determines whether the secondary trigger condition is satisfied. The secondary trigger condition includes the following conditions.
1. Acquiring, through the BCU operation information basic service Basc_BcuOperInfo in the basic service layer, whether a remaining available power of a power battery is sufficient.
2. Acquiring, through the BCU operation information basic service Basc_BcuOperInfo in the basic service layer, whether a long-term discharge power of the power battery is sufficient.
3. Acquiring, through the high voltage request basic service Basc_HvActvReq in the basic service layer, whether a high voltage system is operating normally.
4. Whether the full-vehicle network is operating normally.

In some embodiments of the present application, after all the above conditions are satisfied, i.e., after the recharge is triggered, the intelligent recharge system service of the system service layer determines the recharge duration and parameters such as a period for anomaly detection, a period and filtering parameters for voltage detection, and a waiting time between triggers of two recharges, based on environmental and vehicle body information.

Subsequently, the intelligent recharge system service requests the Basc_HvActvReq high voltage request basic service of the VIU to apply a high voltage. After the request is responded to, timing starts, and the connection with the VIU is confirmed every five minutes to ensure that the vehicle body is in a high voltage state normally, until any of the following normal exit conditions is satisfied.
1. A recharge time reaches a preset duration.
2. A current is continuously less than a current preset value for a period of time.
3. It is known through a BCU operation information basic service that an available energy decreases by a certain value during the recharge process, for example, when the available energy decreases by 2 kw or more in total during the recharge process, the exit condition is satisfied.
4. It is known through the power gear service of the enhanced service layer that the vehicle is unlocked.
5. It is known through the IBS sensor information that a power signal is higher than a power preset value.

In some embodiments of the present application, when any of the following conditions is satisfied during the recharge process, the recharge is exited abnormally, and the causes of the anomaly, which are as follows, are recorded.
1. It is known through the BCU operation information basic service of the basic service layer that the remaining available power of the power battery is insufficient.
2. It is known through the BCU operation information basic service of the basic service layer that the long-term discharge power of the power battery is insufficient.
3. It is known through the high voltage request basic service of the basic service layer that the high voltage system has a fault.
4. A full-vehicle network anomaly occurs.

After the anomaly occurs, the continuous anomaly count within the current wake-up cycle is incremented by 1, and the total anomaly count is incremented by 1.

When an anomaly related to the power battery occurs (i.e., the 1st and 2nd anomalies above), the intelligent recharge service sends an instruction to the SCR core processor through the Basc_IBSInfo basic service to disable the intelligent recharge service, i.e., when the MCU sleeps, the intelligent recharge service will not be awakened due to the voltage being lower than the preset value.

Here, the disable instruction is sent to the SCR core, meaning that under normal circumstances, after detecting a low voltage, the SCR core will awaken a processor where the intelligent recharge service resides, and then the intelligent recharge service will run. After the SCR core receives the disable instruction, even if it detects a low voltage, it will not awaken the processor.

When other anomalies occur (i.e., the 3rd and 4th anomalies above), the SCR core wake-up mode is changed to timed wake-up through the Basc_IBSInfo basic service, i.e., the MCU is awakened every half hour when the voltage is lower than the preset value, in the hope that the anomaly of the high voltage system and the full-vehicle network has been recovered. If the anomaly occurs continuously for 4 times, it is directly disabled.

In some embodiments of the present application, if the MCU is not asleep after the anomaly occurs, preconditions are judged again after a set time (e.g., half an hour) and the high voltage service is requested again. If successful, the continuous anomaly count is reset, and the SCR core wake-up mode is restored to low-voltage wake-up.

In some embodiments of the present application, after the recharge ends, the system also sends a primary trigger reason, a secondary trigger reason, a normal end reason, an abnormal end reason, a wake-up count, a total recharge count, and an abnormal end count to a cloud platform through the Basc_IBSInfo basic service communication interface for analysis.

In some embodiments of the present application, when all the above abnormal conditions are recovered, the intelligent recharge restores the trigger source and sends a notification externally, indicating that the intelligent recharge service is restored and enabled.

In some embodiments of the present application, an electronic device is also provided, including: one or more processors; and a storage apparatus, configured to store one or more programs, where when the one or more programs are executed by the one or more processors, the electronic device is caused to implement the SOA-based intelligent recharge control method for the vehicle provided in the various embodiments above.

In some embodiments of the present application, a computer-readable storage medium is also provided, having a computer program stored thereon, where when the computer program is executed by a processor of a computer, the computer is caused to execute the SOA-based intelligent recharge control method for the vehicle as described above. The computer-readable storage medium may be included in the electronic device described in the above embodiments, or may exist independently without being assembled into the electronic device.

In some embodiments of the present application, a vehicle is also provided, where the vehicle is provided with an electronic device, the electronic device includes: one or more processors; and a storage apparatus, configured to store one or more programs, where when the one or more programs are executed by the one or more processors, the electronic device is caused to implement the SOA-based intelligent recharge control method for the vehicle as described in the above embodiments.

From the above embodiments, it can be seen that the present application organizes the system in a loosely coupled manner through the SOA, realizes a modular vehicle recharge service function, enables services to be shared and reused between different systems and applications, and improves the flexibility, scalability, and maintainability of the vehicle recharge service function.

The above description is only an embodiment of the present application and is not intended to limit the protection scope of the present application. Any modifications, equivalent substitutions, and improvements made within the spirit and scope of the present application are included in the protection scope of the present application.

What is claimed is:

1. A service-oriented architecture (SOA)-based intelligent recharge control method for a vehicle, wherein the SOA at least comprises a system service layer, a basic service layer, an enhanced service layer, an atomic service layer, and an input/output (I/O) abstraction layer; wherein the method comprises:
acquiring, by an intelligent recharge system service of the system service layer, information from the basic service layer, the enhanced service layer, and the atomic service layer, and determining whether a trigger condition for an intelligent recharge service is satisfied;
when the trigger condition is satisfied, calculating, by the intelligent recharge system service, recharge information based on environmental and vehicle body information, wherein the recharge information comprises a recharge duration;
receiving, by a high voltage request basic service of the basic service layer, an instruction from the intelligent recharge system service to control the vehicle to be applied with a high voltage, and performing recharge according to the recharge duration; and
after the recharge ends, controlling, by the intelligent recharge system service, the vehicle to exit the recharge, and sending process record information to a cloud platform through a communication interface of the basic service layer.

2. The intelligent recharge control method for the vehicle according to claim 1, wherein the trigger condition comprises a primary trigger condition and a secondary trigger condition; the intelligent recharge system service is started when the primary trigger condition and the secondary trigger condition are both satisfied.

3. The intelligent recharge control method for the vehicle according to claim 2, wherein the enhanced service layer comprises a power gear service, wherein when a power gear is an ON gear, the intelligent recharge system service is disabled; when the power gear is an OFF gear and after a preset duration is satisfied, a power supply voltage atomic service of the atomic service layer acquires a full-vehicle voltage value, the system service layer calculates an average voltage value, and when the average voltage value is lower than a preset value, the primary trigger condition is satisfied.

4. The intelligent recharge control method for the vehicle according to claim 2, wherein after a full-vehicle network is completely asleep, when a semiconductor control rectifier (SCR) core processor monitors that a voltage of the I/O abstraction layer is lower than a preset value, the primary trigger condition is satisfied, and a microprogrammed control unit (MCU) is awakened.

5. The intelligent recharge control method for the vehicle according to claim 3, wherein after the primary trigger condition is satisfied, the basic service layer pulls up a full-vehicle network through a basic service, acquires vehicle information and environmental information of a vehicle controller (VIU), and determines whether the secondary trigger condition is satisfied.

6. The intelligent recharge control method for the vehicle according to claim 5, wherein the acquiring the vehicle information and the environmental information of the vehicle controller (VIU), and determining whether the secondary trigger condition is satisfied comprises: acquiring, through a basic counter unit (BCU) operation information basic service in the basic service layer, whether a remaining available power of a power battery is sufficient, and whether a long-term discharge power of the power battery is sufficient; determining, through the high voltage request basic service in the basic service layer, whether a high voltage system is operating normally; determining whether the full-vehicle network is operating normally; and in a case that results of all the above determinations are normal, then determining that the secondary trigger condition is satisfied.

7. The intelligent recharge control method for the vehicle according to claim 1, wherein the recharge information further comprises a period for anomaly detection, a period and filtering parameters for voltage detection, and a waiting time between triggers of two recharges.

8. The intelligent recharge control method for the vehicle according to claim 1, wherein an end of the recharge comprises a normal end and an abnormal end; after the abnormal end, an MCU wake-up mode atomic service of the atomic service layer calls an MCU wake-up mode I/O abstraction service of the I/O abstraction layer to send an instruction to an SCR core to periodically wake up the vehicle; and after an occurrence count of an anomaly exceeds a set value, a disable instruction is sent to the SCR core until the vehicle is unlocked.

9. The intelligent recharge control method for the vehicle according to claim 8, wherein when any exit condition is satisfied, the recharge of the vehicle is normally ended; the exit condition comprises that: a recharge time reaches a preset duration; a current is continuously less than a current preset value for a period of time; it is known through a BCU operation information basic service of the basic service layer that an available energy decreases by an energy set value during a recharging process; it is known through a power gear service of the enhanced service layer that the vehicle is unlocked; and it is known through an intelligent battery sensor (IBS) sensor information service of the basic service layer that a power signal sent by an IBS sensor is higher than a power preset value.

10. The intelligent recharge control method for the vehicle according to claim 8, wherein when any disconnection condition is satisfied, the recharge of the vehicle is abnormally ended; the disconnection condition comprises that: it is known through a BCU operation information basic service of the basic service layer that a remaining available power of a power battery is insufficient; it is known through the BCU operation information basic service of the basic service layer that a long-term discharge power of the power battery is insufficient; it is known through a high voltage request basic service of the basic service layer that a high voltage system has a fault; and a full-vehicle network anomaly occurs.

11. The intelligent recharge control method for the vehicle according to claim 1, wherein the process record information comprises a primary trigger reason, a secondary trigger reason, a normal end reason, an abnormal end reason, a wake-up count, a total recharge count, and an abnormal end count.

12. An electronic device, comprising:
one or more processors; and
a storage apparatus, configured to store one or more programs, wherein the one or more processors, when executing the one or more programs, is configured to:
acquire, by an intelligent recharge system service of a system service layer of a service-oriented architecture (SOA), information from a basic service layer, an enhanced service layer, and an atomic service layer of the SOA, and determine whether a trigger condition for an intelligent recharge service is satisfied, wherein the SOA further comprises an input/output (I/O) abstraction layer;
when the trigger condition is satisfied, calculate, by the intelligent recharge system service, recharge information based on environmental and vehicle body information, wherein the recharge information comprises a recharge duration;
receive, by a high voltage request basic service of the basic service layer, an instruction from the intelligent recharge system service to control a vehicle to be applied with a high voltage, and perform recharge according to the recharge duration; and
after the recharge ends, control, by the intelligent recharge system service, the vehicle to exit the recharge, and send process record information to a cloud platform through a communication interface of the basic service layer.

13. The electronic device according to claim 12, wherein the trigger condition comprises a primary trigger condition and a secondary trigger condition; the intelligent recharge system service is started when the primary trigger condition and the secondary trigger condition are both satisfied.

14. The electronic device according to claim 13, wherein the enhanced service layer comprises a power gear service, wherein when a power gear is an ON gear, the intelligent recharge system service is disabled; when the power gear is an OFF gear and after a preset duration is satisfied, a power supply voltage atomic service of the atomic service layer acquires a full-vehicle voltage value, the system service layer calculates an average voltage value, and when the average voltage value is lower than a preset value, the primary trigger condition is satisfied.

15. The electronic device according to claim 13, wherein after a full-vehicle network is completely asleep, when a semiconductor control rectifier (SCR) core processor monitors that a voltage of the I/O abstraction layer is lower than a preset value, the primary trigger condition is satisfied, and a microprogrammed control unit (MCU) is awakened.

16. The electronic device according to claim 14, wherein after the primary trigger condition is satisfied, the basic service layer pulls up a full-vehicle network through a basic service, acquires vehicle information and environmental information of a vehicle controller (VIU), and determines whether the secondary trigger condition is satisfied.

17. The electronic device according to claim 16, wherein the one or more processors are configured to: acquire, through a BCU operation information basic service in the basic service layer, whether a remaining available power of a power battery is sufficient, and whether a long-term discharge power of the power battery is sufficient; determine, through the high voltage request basic service in the basic service layer, whether a high voltage system is operating normally;
determine whether the full-vehicle network is operating normally; and in a case that results of all the above determinations are normal, then determine that the secondary trigger condition is satisfied.

18. The electronic device according to claim 12, wherein the recharge information further comprises a period for anomaly detection, a period and filtering parameters for voltage detection, and a waiting time between triggers of two recharges.

19. A non-transitory computer-readable storage medium, having a computer program stored thereon, wherein when the computer program is executed by a processor of a computer, the computer is caused to execute following operations:
acquiring, by an intelligent recharge system service of a system service layer of a service-oriented architecture (SOA), information from a basic service layer, an enhanced service layer, and an atomic service layer of the SOA, and determining whether a trigger condition for an intelligent recharge service is satisfied, wherein the SOA further comprises an input/output (I/O) abstraction layer;
when the trigger condition is satisfied, calculating, by the intelligent recharge system service, recharge information based on environmental and vehicle body information, wherein the recharge information comprises a recharge duration;
receiving, by a high voltage request basic service of the basic service layer, an instruction from the intelligent recharge system service to control a vehicle to be applied with a high voltage, and performing recharge according to the recharge duration; and
after the recharge ends, controlling, by the intelligent recharge system service, the vehicle to exit the recharge, and sending process record information to a cloud platform through a communication interface of the basic service layer.

20. A vehicle, provided with an electronic device, wherein the electronic device comprises:
one or more processors; and
a storage apparatus, configured to store one or more programs, wherein when the one or more programs are executed by the one or more processors, the electronic device is caused to implement the service-oriented architecture (SOA)-based intelligent recharge control method for the vehicle according to claim 1.
